(19) United States
(12) Patent Application Publication
(10) Pub. No.: US 2007/0260590 A1
(43) Pub. Date: Nov. 8, 2007

(54) Method to Query Large Compressed Audio Databases

(76) Inventor: Prabindh Sundareson, Madurai (IN)

Correspondence Address: TEXAS INSTRUMENTS INCORPORATED, P O BOX 655474, M/S 3999, DALLAS, TX, 75265, US

(21) Appl. No.: 11/742,067

(22) Filed: Apr. 30, 2007

Related U.S. Application Data
(60) Provisional application No. 60/746,058, filed on May 1, 2006.

(51) Int. Cl. G06F 17/30

(52) U.S. Cl. 707/3

(57) ABSTRACT

A method of operating a digital music system includes inputting the location where music data files are stored, automatically profiling music data files, inputting a query of a type of music data, generating an ordered playlist of music data files satisfying the query and playing the playlist. Input can be via keyboard or via an automatic speech recognition system. The automatically profiling includes pitch tracking to determine whether the music data file includes male vocals, female vocals or no vocals. This invention is useful for compressed music data files, where the number of music data files is large.

### CLAIM OF PRIORITY

This application claims priority under 35 U.S.C. 119(e) (1) to U.S. Provisional Application No. 60/746,058 filed May 1, 2006.

### TECHNICAL FIELD OF THE INVENTION

The technical field of this invention is formulating a query, to efficiently fetch a specific audio/multimedia track list from a large database of music.

### BACKGROUND OF THE INVENTION

U.S. patent application Ser. No. 10/424,393 entitled APPARATUS AND METHOD FOR AUTOMATIC CLASSIFICATION/IDENTIFICATION OF SIMILAR COMPRESSED AUDIO FILES filed Apr. 25, 2005 disclosed a mechanism to classify audio files based on information in the compressed MPEG domain. A similar mechanism can be used in the non-compressed domain. These methods permit derivation of a database of files in a collection containing distinguishing information about each file. However, an efficient query mechanism is needed to use such a database in order to fetch a specific audio/multimedia track.

### SUMMARY OF THE INVENTION

This invention uses audio identification techniques, apart from existing database information in the song itself, to formulate a database query. This invention can reliably differentiate genres of music, is intuitive in use and is suitable for implementing on portable platforms.

This invention allows the user to fetch a list of audio tracks that relate to the users tastes without having to listen to entire file list. It is useful in restricted scenarios like automobile environments.

### BRIEF DESCRIPTION OF THE DRAWINGS

These and other aspects of this invention are illustrated in the drawings, in which:

FIG. 1 illustrates a block diagram of a digital music system to which this invention is applicable;

FIG. 2 illustrates a functional operation diagram of one embodiment of this invention;

FIG. 3 illustrates a flow chart of actions in response to a spoken query;

FIG. 4 is a flow chart of a sample personal computer application of this invention;

FIG. 5 illustrates a first example window of the program of FIG. 4;

FIG. 6 illustrates a second example window of the program of FIG. 4; and

FIG. 7 illustrates a third example window of the program of FIG. 4.

### DETAILED DESCRIPTION OF PREFERRED EMBODIMENTS

This invention is needed to handle the volume of digital music that can now be stored. A compact disk would generally hold up to an hour of music or fifteen to twenty songs. This is generally a small enough number of songs that a user would not be confused about the selections available on any CD. Currently, digital music can be compressed for easier storage and transmission. A common format is the audio compression known as MPEG Layer 3 (MP3). A compact disk storing such compressed music data could store eight to ten hours of music or more than a hundred songs. Portable music players and automobile music players may store compressed music data on a hard disk drive. This provides the possibility of storing thousands of songs. This number generally exceeds the capacity of a user to remember the selections and order of music stored. Thus there is a need in the art for a manner to find desired music selections analogous to a data base query.

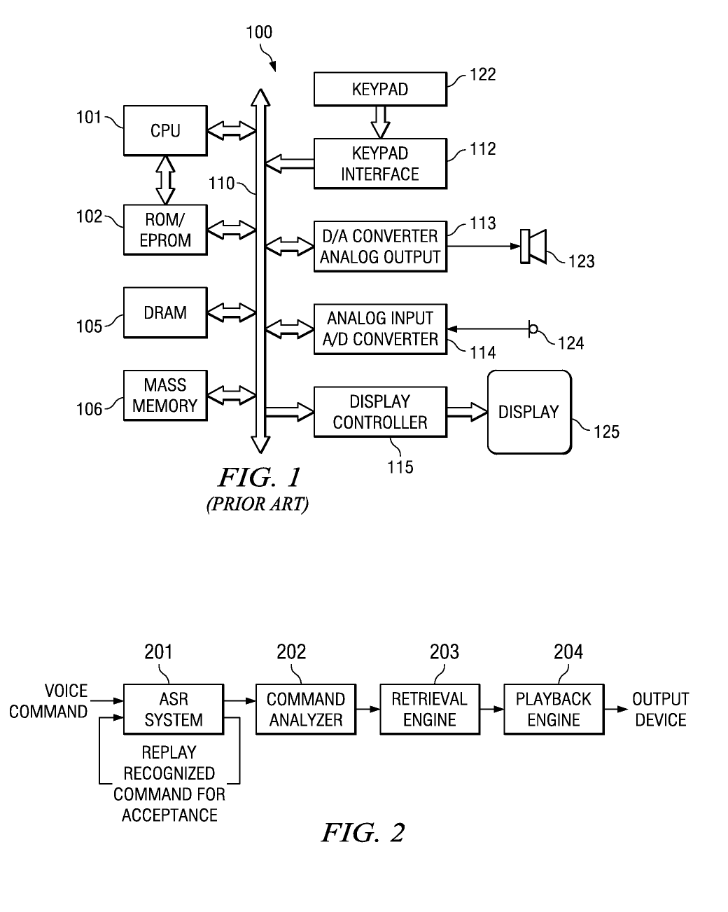

FIG. 1 illustrates a block diagram of a digital music system 100. The digital music system 100 stores digital music files on mass memory 106. Mass memory 106 can be a hard disk drive or a compact disk drive accommodating a compact disk. These digital music files may be compressed digital music in a known format such as MP3. Digital music are recalled in proper order and presented to the user via speakers 123. FIG. 1 illustrates only a single speaker 123 but those skilled in the art would realize it is customary to supply left and right channel signals to a pair or speakers. In a portable system speakers 123 could take the form of a set of headphones. Digital music system 100 includes: core components CPU 101, ROM/EPROM 102, DRAM 105; mass memory 106; system bus 110; keyboard interface 112; D/A converter and analog output 113; analog input and A/D converter 114; and display controller 115. Central processing unit (CPU) 101 acts as the controller of the system giving the system its character. CPU 101 operates according to programs stored in ROM/EPROM 102. Read only memory (ROM) is fixed upon manufacture. Erasable programmable read only memory (EPROM) may be changed following manufacture even in the hand of the consumer in the filed. As an example, following purchase the consumer may desire to change functionality of the system. The suitable control program is loaded into EPROM. Suitable programs in ROM/EPROM 102 include the user interaction programs, which are how the system responds to inputs from keyboard 122 and displays information on display 125, the manner of fetching and controlling files from mass memory 106 and the like. In particular the program to perform the database access of this invention is stored in ROM/EPROM 102. A typical system may include both ROM and EPROM.

System bus 110 serves as the backbone of digital music system 100. Major data movement within digital music system 100 occurs via system bus 110.

Mass memory 106 moves data to system bus 110 under control of CPU 101. This data movement would enable recall of digital music data from mass memory 106 for presentation to the user.

Keyboard interface 112 mediates user input from keyboard 122. Keyboard 122 typically includes a plurality of momentary contact key switches for user input. Keyboard interface 112 senses the condition of these key switches of keyboard 122 and signals CPU 101 of the user input. Keyboard interface 112 typically encodes the input key in a code that can be read by CPU 101. Keyboard interface 112 may signal a user input by transmitting an interrupt to CPU 101 via an interrupt line (not shown). CPU 101 can then read the input key code and take appropriate action.

Digital to analog (D/A) converter and analog output 112 receives the digital music data from mass memory 106. Digital to analog (D/A) converter and analog output 112 provides an analog signal to speakers 123 for listening by the user.

Analog input and analog to digital (A/D) converter 114 receives a voice input from microphone 124. The corresponding digital data is supplied to system bus 110 for temporary storage in DRAM 105 and analysis by CPU 101. The use of voice input is further explained below.

Display controller 115 controls the display shown to the user via display 125. Display controller 115 receives data from CPU 101 via system bus 110 to control the display. Display 125 is typically a multiline liquid crystal display (LCD). This display typically shows the title of the currently playing song. It may also be used to aid in the user specifying playlists and the like. In a portable system, display 125 would typically be located in a front panel of the device. In an automotive system, display 125 would typically be mounted in the automobile dashboard.

DRAM 105 provides the major volatile data storage for the system. This may include the machine state as controlled by CPU 101. Typically data is recalled from mass memory 105 and buffered in DRAM 105 before decompression by CPU 101. DRAM 105 may also be used to store intermediate results of the decompression.

The query for retrieving a specific track from a database includes: a language from a selection; high and low beats; yes to no electronic music; the percentage of the following in the track loud sections, instruments and vocals; and the type of vocals such as male or female voice.

Upon an input query the system calculates a Euclidean distance for each of the available entries in the database. Since the query also contains binary (yes/no) information, the distance is magnified by the presence or absence of the corresponding item. For example, if the language of the query does not match the language of a sample item in the database, a factor ‘N’ is added to the distance. This ensures that the item is ordered far from the query. For audio the presence of beats is an important characteristic of a song. Accordingly, a lot of weight is given to the presence of beats. The type of vocals also plays an important role. The system produces an ordered list using the distance of each database item from the reference input.

In a personal computer based application, the reference input can be set via user fields corresponding to the queries listed above in an application menu, or by selecting a reference song. In a portable player application, the reference input can be set by presets. A preset is set by the manufacturer or previously configured by the user. In an automotive environment including a HDD or CD storage based audio player, several restrictions apply in entering these configurations.

In a desktop computer, it is easy to setup the parameters by keyboard input into an application menu. In automotive applications, it is difficult to set the various parameters of the query. This is difficult in an automobile because: the space for setting up an elaborate menu is limited; and automobile usage patterns do not allow for long periods of setup. A different query setup mechanism is needed to input the query. In this case it useful to have a high-level query setup that uses the low level information described above. In this invention, a speech recognition interface is used to create a high level query. The high level query can have one or more of these attributes: genre such as “Classic Rock”; name of album such as “Brothers in Arms”; name of artist such as “Dire Straits”; language such as “English”; group qualifier such as “All” which will retrieve all tracks; and male/female identifier.

Table 1 shows a mapping of these high level queries into a low level query.

TABLE 1

| | |
|---|---|
| Genre | For each supported genre, a typical |
| | track in that genre is analyzed and |
| | stored in an ordered database. |
| Album | Existing databases like Gracenote CD |
| | Database (CDDB), ID3 or ASF information |
| | when present. |
| Artist | Existing databases like CDDB, ID3 or ASF |
| | information when present. |
| Language | A language identification mechanism. |
| Male/female | A mechanism to track the pitch of the |
| identifier | vocals. |

FIG. 2 illustrates an operational diagram of one embodiment of this invention suitable for use in an automobile music player. Automatic speech recognition (ASR) system 201 receives a voice command input. High end automobiles often already have ASR systems which can be adapted for this invention. In the preferred embodiment, upon recognition ASR system 201 replays the recognized command for confirmation. Upon confirmation, ASR system 201 supplies data corresponding to the recognized voice command to command analyzer 202. Command analyzer 202 translates the recognized voice command into a corresponding data base query. Retrieval engine 203 receives the data base query from command analyzer and retrieves the corresponding music data or pointers to their storage location. Playback engine 204 plays back the corresponding music data via an output device such as speakers 123. Proper programming of digital music system 100 via ROM/EPROM 102 enables this functional operation.

Rather than setting the parameters of the query to retrieve songs of a particular genre, the system recognizes a spoken utterance of the genre/group/album itself. For example, the user speaks “Pop songs” to retrieve pop songs from a mixed database.

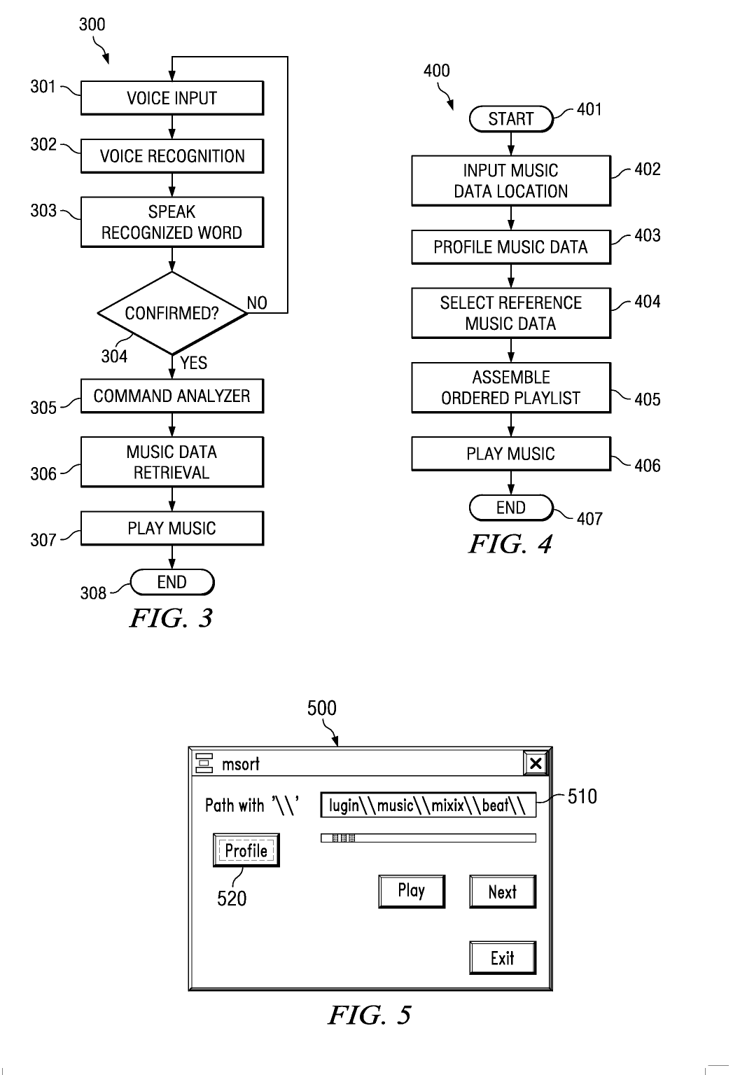

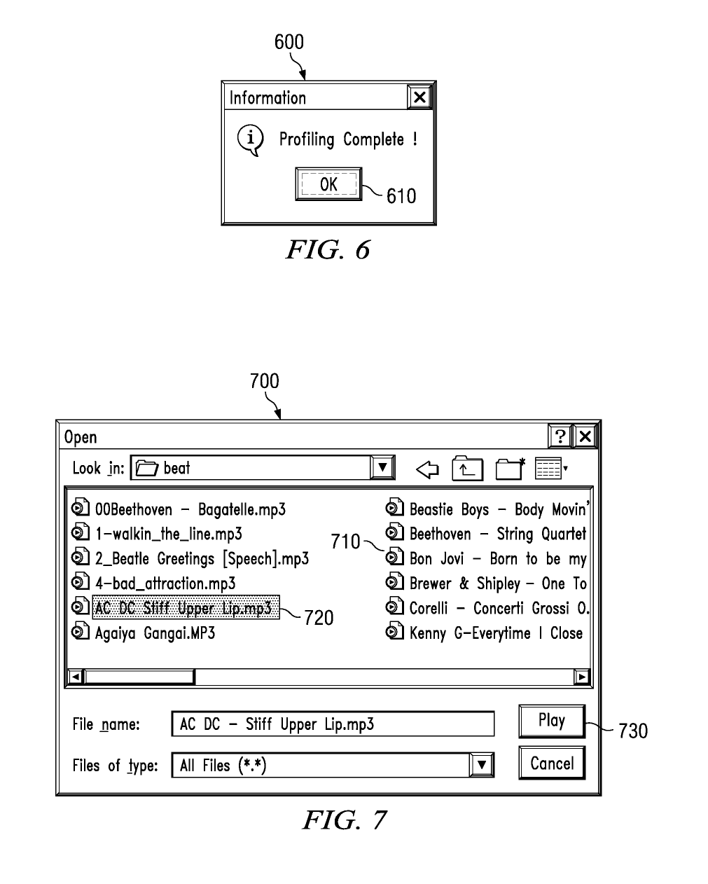

FIG. 3 illustrates a flow chart 300 of actions in response to a spoken query. Voice input block 301 receives the user spoken input. In this example, voice recognition block 302 recognizes the word “pop” and passes this to a command analyzer 305. In block 303 the system speaks the recognized word. This provides user feedback. If the user denies the recognized word (No at test block 304), then flow returns to block 301 with a repeat of the spoken query. If the user confirms the recognized word (Yes at test block 304), flow passes to command analyzer 305.

Command analyzer 305 contains the set of parameters that correspond to each supported keyword. Command analyzer 305 outputs the parameters for the input keyword recognized by automatic speech recognition system. Retrieval block 306 uses these parameters from command analyzer 305 to retrieve all songs that fall in the category “pop” via retrieval engine 203 illustrated in FIG. 2. These songs form part of the generated playlist.

Block 307 plays back this list via playback engine 204 through an output device. In an automotive application this output device would generally be external speakers. In a portable player application this output device would generally be external headphones. A personal computer application could use either speakers or headphones.

FIG. 4 is a flow chart of a sample personal computer application 400 of this invention has been built to demonstrate viability. An automatic speech recognition (ASR) system was not built. As previously mentioned, an ASR system is common on high end automobiles. The sample personal computer application can be used as a backend to such an ASR system.

The sample application is built to run on Windows machines. Computer application 400 begins at start block 401. Computer application 400 receives a user input in block 402 indicating the location of a collection of files from the user. Window 500 from FIG. 5 illustrates this example user input screen. The user enters the path data into window 510. This input may be via keyboard 122 or a voice command entered via ASR system 201. Selection of button 520 activates the system to profile the music data within the selected subfolder (block 403). This music profile preferably employs the technique disclosed in U.S. patent application Ser. No. 10/424,393. Following the music profile, computer application 400 presents window 600 to the user. The user clears this window to continue computer application 400 by selection of button 610.

The application then creates a database of the tracks in the collection. The database consists of:
1. The unique location of the song in the physical media (this could be the cluster number, UDF unique ID, start sector number, or any other unique mechanism to locate the file; and
2. The parameters of the song in terms of the features in Table 1. These parameters are used later during the retrieval process to create the ordered playlist.

The application then creates an ordered playlist (block 404) corresponding to a user query. The ordered playlist contains the primary query song as the first element, followed by other songs ordered according to their distance from the primary query. The distance is a function of the parameters calculated earlier. As an example, the techniques disclosed in U.S. patent application Ser. No. 10/424,393 can be used to create the profile. As noted above, this user query could be input via keyboard 122 or by voice command via ASR system 201. An example of such an ordered playlist is shown at 700 in FIG. 7. File list window 710 shows the ordered playlist. In this example the files are in alphabetical order. The user is then given an option to select a particular file as reference (block 405). Note that FIG. 7 illustrates shaded file 720 selected as a reference. This ordered list is then played back through the personal computer sound card (block 406) following selection via play button 730. The sample application 400 may use DirectX or MFC for this final playback step. Following playback computer application ends at end block 407.

This invention provides the following features. It provides a mechanism to effectively and efficiently query a large database, even in the absence of previously tagged databases (such as CDDB). It enables a mechanism for use in restricted scenarios such as automotive applications has been suggested. An important feature of this mechanism is the mapping from high level queries to low level feature information.

What is claimed is:

1. A method of operating a digital music system comprising the steps of:
inputting from a user an indication of a location where music data files are stored;
automatically profiling each music data file stored at said indicated location;
inputting from the user a query of a type of music data;
generating an ordered playlist of music data files stored at said indicated location satisfying said query; and
playing said playlist of music data files.

2. The method of claim 1, wherein:
said steps of inputting the indication of the location and inputting the query are via a keyboard.

3. The method of claim 1, wherein:
said steps of inputting the indication of the location and inputting the query are via voice commands recognized by an automatic speech recognition system.

4. The method of claim 3, wherein:
said automatic speech recognition system includes verbal feedback to the user of recognized voice commands.

5. The method of claim 3, further comprising the steps of:
analyzing a recognized voice command and producing a query corresponding to said recognized voice command.

6. The method of claim 1, wherein:
said step of automatically profiling each music data file includes pitch tracking to determine whether the music data file includes male vocals, female vocals or no vocals.

7. The method of claim 1, wherein:
said music data files are compressed music data files; and
wherein said step of playing said playlist of music data files includes decompressing each music data file.
